(19) United States
(12) Patent Application Publication
(10) Pub. No.: US 2026/0134289 A1
(43) Pub. Date: May 14, 2026

(54) CALIBRATED PREFERENCE OPTIMIZATION FOR GENERATIVE NEURAL NETWORKS

(71) Applicant: GDM Holding LLC, Mountain View, CA (US)

(72) Inventors: Kyungmin Lee, San Francisco, CA (US); Yinxiao Li, Sunnyvale, CA (US); Feng Yang, Sunnyvale, CA (US); Junfeng He, Fremont, CA (US); Irfan Aziz Essa, Atlanta, GA (US); Ming-Hsuan Yang, Sunnyvale, CA (US); Xiaohang Li, Cupertino, CA (US); Junjie Ke, East Palo Alto, CA (US)

(21) Appl. No.: 19/390,262

(22) Filed: Nov. 14, 2025

Related U.S. Application Data
(60) Provisional application No. 63/720,709, filed on Nov. 14, 2024.

(51) Int. Cl. G06N 3/092; G06N 3/0475

(52) U.S. Cl. CPC G06N 3/092; G06N 3/0475

(57) ABSTRACT

Methods, systems, and apparatus, including computer programs encoded on computer storage media, for training a generative neural network that has parameters. In one aspect, one of the methods include: obtaining a context input; processing, by the generative neural network, the context input to generate a plurality of training outputs; for each objective in a set of objectives and for each of the plurality of training outputs: determining a respective quality score of the training output relative to each other training input in the plurality of training outputs with respect to the objective; and determining a calibrated reward for the training output with respect to the objective based on the respective quality scores of the training output with respect to the objective; selecting a positive training output and a negative training output; and training the generative neural network on the positive training output and the negative training output.

### CROSS-REFERENCE TO RELATED APPLICATIONS

This application claims priority to U.S. Provisional Application No. 63/720,709, filed on Nov. 14, 2024. The disclosure of the prior application is considered part of and is incorporated by reference in its entirety in the disclosure of this application.

### BACKGROUND

This specification relates to training neural networks to generate output data items. For example, the output data items can include text data, audio data, pixel data (that represent an image or a video frame), and so on.

Neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a training system implemented as computer programs on one or more computers in one or more locations that trains a generative neural network based on optimizing a calibrated preference optimization (CaPO) loss.

The subject matter described in this specification can be implemented in particular embodiments so as to realize one or more of the following advantages.

This specification describes a training system that trains, e.g., fine-tunes, a generative neural network, e.g., a diffusion neural network or an auto-regressive generative neural network, to improve the performance of the generative neural network at inference time based on optimizing a calibrated preference optimization (CaPO) loss.

Some existing fine-tuning techniques that directly optimize raw reward scores are prone to overfitting and reward hacking if the reward scores are not properly calibrated. Even optimizing for a single reward can lead to significant performance loss. Some existing preference optimization techniques often fall short in exploiting the rich information from reward signals, as they typically only consider pairwise preference distribution. Thus, they lack generalization to multi-preference scenarios. A common practice for multi-reward optimization is using the weighted sum of rewards as a proxy. However, these rigid formulations often cannot effectively consider all aspects of utilities and may lead to suboptimal performance (e.g., biasing the model towards certain reward signals).

To address these issues that arise when using reward models for preference optimization in generative neural networks, the CaPO loss applies post-hoc reward calibration based on pairwise comparisons. The training system can broadly apply the CaPO loss to any of a variety of training scenarios, ranging from a single objective setting to a multi-objective setting with a pair selection strategy for Pareto optimality, and can additionally incorporate a timestep-aware loss weighting mechanism to improve reward score optimization when the generative neural network is configured as a diffusion neural network.

Leveraging the CaPO loss, the training system can train the generative neural network to generate training output data items that improve the reward scores generated by one or more reward models while mitigating reward overfitting and reward hacking. Reward overfitting occurs when a generative neural network is trained too closely to the specific reward scores generated by a reward model, which can result in performance loss in generalization. Reward hacking is a similar risk of performance loss where the generative neural network finds shortcuts to maximize the reward scores provided by the reward model without actually achieving the desired preference between multiple output data items.

By approximating the preference (expected win-rate) through calibration, the CaPO loss mitigates reward overfitting and hacking and thus improves the effectiveness of the training. The training system described in this specification can therefore train the generative neural network to generate output data items that have a higher quality with respect to each of one or more objectives than other training systems that do not use the CaPO loss with no additional consumption of computing resources (e.g., processing resources, memory resource, or both). For example, the training system can train a diffusion neural network to generate images with higher quality (e.g., improved image aestheticism, or more legible text rendering) and better prompt alignment with no additional consumption of computing resources during the fine-tuning process compared to those other training systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is an example illustration of operations performed by the training system to train the neural network.

FIG. 3 is a flow diagram of an example process for training a neural network.

FIG. 4 shows an example of performance improvement achieved by the described fine-tuning technique when the output data items are images and the context inputs are text prompts.

Like reference numbers and designations in the various drawings indicate like elements.

### DETAILED DESCRIPTION

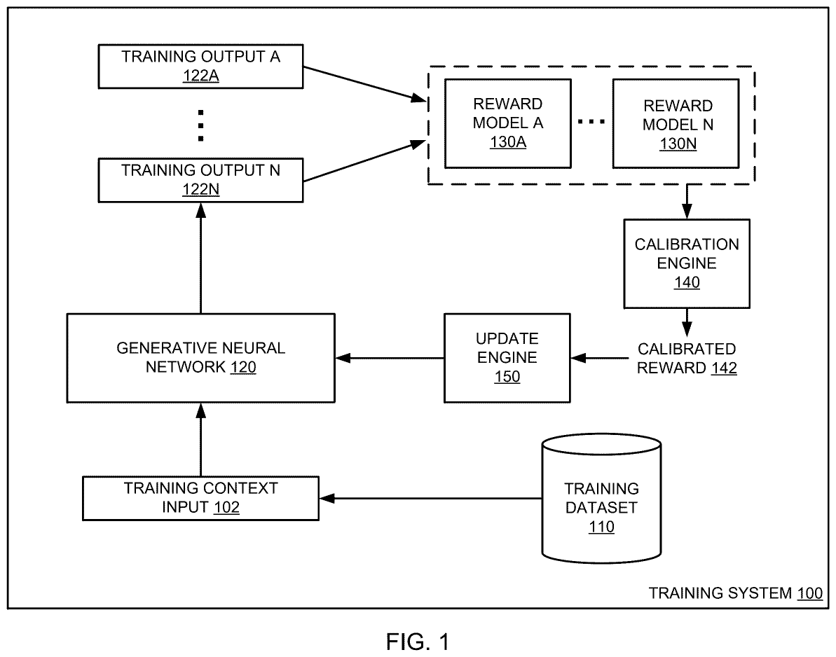

FIG. 1 shows an example training system 100. The training system 100 is an example of a system implemented as computer programs on one or more computers in one or more locations that trains a generative neural network 120 based on optimizing a calibrated preference optimization (CaPO) loss.

The generative neural network 120 can be configured through training to generate an output data item conditioned on a context input (also be referred to as a “conditioning input” or a “prompt”) that provides context for the output data item. In some cases, the context input specifies a target value for each of one or more target properties of the output data item.

This specification generally describes the generative neural network 120 being a diffusion neural network that generates the output data item across multiple updating iterations by performing a reverse diffusion process.

Examples of such neural networks include those described in Saharia, Chitwan, et al. Photorealistic text-to-image diffusion models with deep language understanding. Advances in Neural Information Processing Systems 35 (2022): 36479-36494; Jonathan Ho, Ajay Jain, and Pieter Abbeel. Denoising Diffusion Probabilistic Models. arXiv:2006.11239, 2020; and Yang Song and Stefano Ermon. Generative Modeling by Estimating Gradients of the Data Distribution. NeurIPS, 2019; and Zhao, Yang, et al. Mobile diffusion: Instant text-to-image generation on mobile devices. European Conference on Computer Vision. Cham: Springer Nature Switzerland, 2024.

The diffusion neural network can be any appropriate diffusion neural network that is configured to, at each updating iteration of the reverse diffusion process, receive a denoising input that includes an intermediate (noisy) representation of an output data item and a context input and to generate a denoising output for the updating iteration from which an updated representation of the output data item can be derived.

If the updating iteration is the first updating iteration in the reverse diffusion process, the intermediate representation of the output data item is the initial representation of the output data item. For example, the initial representation of the output data item can be generated based on sampling each value in the representation from a corresponding noise distribution, e.g., a Gaussian distribution, or a different noise distribution.

For any subsequent updating iteration, the intermediate representation of the output data item is the updated representation of the output data item that has been generated in the immediately preceding updating iteration.

In some implementations, the diffusion neural network performs a reverse diffusion process in output space, e.g., pixel space when the output data items are images. In this example, when the output data items are images, the representations operated on and generated by the diffusion neural network have values for each pixel that specify color values, e.g., RGB values or another color encoding scheme.

Examples of such diffusion neural networks include Imagen, as described in Saharia, Chitwan, et al. Photorealistic text-to-image diffusion models with deep language understanding. Advances in Neural Information Processing Systems 35 (2022): 36479-36494.

In some other implementations, the diffusion neural network performs a reverse diffusion process in latent space, e.g., in a latent space that is lower-dimensional than the output space. That is, the representations operated on by the diffusion neural network are latent representations and the values in the representations are learned, latent values, e.g., rather than color values when the output data items are images.

Examples of such diffusion neural networks include MobileDiffusion, as described in Zhao, Yang, et al. Mobilediffusion: Instant text-to-image generation on mobile devices. European Conference on Computer Vision. Cham: Springer Nature Switzerland, 2024.

In these implementations, during training, the diffusion neural network can be associated with an encoder to encode training data items into the latent space and, after training and to generate new output data items, a decoder neural network that receives an input that includes a latent representation of an output data item and decodes the latent representation to reconstruct the output data item. For example, when the output data items are images, the encoder and decoder can have been trained jointly on an image reconstruction objective, e.g., a VAE objective, a VQ-GAN objective, or a VQ-VAE objective.

In some implementations, at each updating iteration in the reverse diffusion process, the diffusion neural network directly generates the updated representation of the output data item, e.g., the denoising output for the updating iteration includes the updated representation of the output image.

In some implementations, at each updating iteration in the reverse diffusion process, the diffusion neural network indirectly generates the updated representation of the output data item, e.g., the diffusion output for the updating iteration includes a noise term computed by the diffusion neural network for the updating iteration, and the updated representation of the output data item can then be generated by applying a diffusion sampler to the denoising output.

For example, when the diffusion neural network performs a reverse diffusion process in pixel space, the noise term can be an estimate of the noise, as computed by the diffusion neural network, that has been added to the output data item to arrive at the intermediate (noisy) representation of the output data item.

As another example, when the diffusion neural network performs a reverse diffusion process in latent space, the noise term can be an estimate of the noise, as computed by the diffusion neural network, that has been added to a latent representation of the output data item to arrive at the intermediate representation of the output data item.

There are many appropriate diffusion samplers that can be used to update the intermediate representation. Just as a few examples the system can use the DDPM (Denoising Diffusion Probabilistic Model) sampler, the DDIM (Denoising Diffusion Implicit Model) sampler or another appropriate sampler.

The diffusion neural network can be conditioned on the context input in any of a variety of ways.

As one example, an encoder neural network can be used to generate one or more embeddings that represent the context input and the diffusion neural network can include one or more cross-attention layers that each cross-attend into the one or more embeddings.

An embedding, as used in this specification, is an ordered collection of numerical values, e.g., a vector of floating point values or other types of values.

For example, when the context input is text, a text encoder neural network, e.g., a Transformer neural network, can be used to generate a fixed or variable number of text embeddings that represent the context input.

When the context input is an image, an image encoder neural network, e.g., a convolutional neural network or a vision Transformer neural network, can be used to generate a set of embeddings that represent the image.

When the context input is audio, an audio encoder neural network, e.g., an audio encoder neural network that has been trained jointly with a decoder neural network as part of a neural audio codec, can be used to generate one or more embeddings that encode the audio.

When the context input is a scalar value, an embedding matrix can be used to map the scalar value or a one-hot representation of the scalar value to an embedding.

In some cases, the context input includes multiple different types of inputs, e.g., two or more of text, images, bound values, or context embeddings.

In some of these cases, one or more initial embeddings can be generated for each of the different types of inputs, i.e., using an appropriate encoder neural network as described above, and then processing the initial embeddings for all of the different types of inputs using a Transformer encoder neural network to update each of the initial embeddings to generate a set of final embeddings. The one or more cross-attention layers within the diffusion neural network can then cross-attend into the set of final embeddings.

In others of these cases, different cross-attention layers within the diffusion neural network can cross-attend into embeddings of different types of context inputs.

In yet others of these cases, the system can concatenate the initial embeddings of the different types of inputs along the sequence dimension and then the one or more cross-attention layers can cross-attend into the concatenated set of final embeddings.

As another example, the diffusion neural network can include one or more other types of neural network layers that are conditioned on the one or more embeddings. Examples of such layers include Feature-wise Linear Modulation (FILM) layers, layers with conditional gated activation functions, and so on.

The denoising input at any given updating iteration can also include data defining a noise level for the iteration. Generally, each updating iteration has a corresponding time step t and the noise level for the updating iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the context input.

More generally, however, the generative neural network 120 can be any appropriate generative neural network 120 that can map a context input to an output data item, e.g., an auto-regressive generative neural network, a non-auto-regressive masked token generation neural network, a normalizing flows model, the generator of a generative adversarial neural network, a rectified flow or multi-step consistency model or another type of denoising model, and so on.

As a particular example, the generative neural network 120 can be an auto-regressive generative neural network, e.g., as described in Comanici, Gheorghe, et al. Gemini 2.5: Pushing the frontier with advanced reasoning, multimodality, long context, and next generation agentic capabilities. arXiv preprint arXiv:2507.06261 (2025), which is configured to process an input sequence that is made up of a first plurality of tokens to generate, based on the input sequence, an output sequence that is made up of a second plurality of tokens in an auto-regressive manner, by generating each particular token in the output sequence conditioned on a current input sequence that includes any (e.g. all) tokens that precede the particular token in the output sequence, i.e., tokens that have already been generated for any previous positions in the output sequence that precede the particular position of the particular token, and the input sequence.

In this example, the input sequence represents a context input, and the output sequence represents the output data item. The first plurality of tokens, the second plurality of tokens, or both can include tokens (“vocabulary tokens” or “hard tokens”) selected from a vocabulary. Additionally or alternatively, the first plurality of tokens, the second plurality of tokens, or both can include tokens (“soft tokens”) that are trainable, continuous vector embeddings.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text.

For example, the vocabulary of tokens can include image tokens that represent a discrete set of image patch embeddings of an image that can be generated by an image encoder neural network based on processing the image patches of the image. A token as described herein can represent a real-world image, e.g. one that has been captured by a camera.

As another example, the vocabulary of tokens can include audio tokens that represent an audio waveform, e.g. code vectors in a codebook of a quantizer, e.g., a residual vector quantizer.

The training system 100 performs “fine-tuning,” i.e., further training, of the generative neural network 120 to improve the performance of the generative neural network 120 in generative tasks, i.e., tasks that require generating output data items using the generative neural network 120.

That is, prior to being trained by the training system 100, the training system 100 or another training system has trained the generative neural network 120 on a different objective—and the training system 100 fine-tunes, i.e., further trains, the already-trained generative neural network 120 on the CaPO loss.

In other words, prior to being trained by the system 100, the generative neural network 120 can have been trained conventionally, using any appropriate objective functions, e.g., one or more unsupervised or self-supervised objective functions, on one or more unlabeled or labeled training datasets.

For example, when configured as a diffusion neural network, the generative neural network 120 can have been trained on a set of training data items on a diffusion score matching objective or a variant thereof.

As another example, when configured as an auto-regressive generative neural network, the generative neural network 120 can have been trained on a set of training data items on a next token prediction objective or a variant thereof.

As a result of this prior training, the generative neural network 120 can generate output data items conditioned on context inputs, but may have limitations that hinder its capability of deployment in an inference system.

In some cases, the generative neural network 120 may generate output data items with sub-optimal qualities. For example, it may generate images or audio with artifacts (thus having a low fidelity), blurriness, or a lack of visual or acoustic appeal.

Even if the generative neural network 120 can generate high-quality output data items, e.g., high-quality images or audio, in some cases it may have difficulty in accurately aligning the output data items with the preference (e.g., human preference) between multiple output data items, i.e., may have difficulty generating data items that would be preferred by users.

For example, the generative neural network 120 may be able to generate high-quality images with good aesthetics, but may not be able to consistently generate output data items that match human preferences of aesthetics, style, or quality of the images.

As a particular example of this, the generative neural network 120 may generate a hyper-polished, visually generic, or sterile image—that is usually less preferred by a human—conditioned on a context input that is in the format of a text prompt: “generate a beautiful landscape.”

Additionally or alternatively, even if the generative neural network 120 can generate high-quality output data items, in some cases it may have difficulty in accurately aligning the output data item with the corresponding context input, e.g., when the context input requests an output data item that has a specific value for a target property.

For example, the generative neural network 120 may be able to generate high-quality images with good aesthetics, but may not be able to consistently accurately render text that is specified by the context input, e.g., may generate text that is illegible or that does not match exactly the text that is specified in the context input.

As another example, the generative neural network 120 may be able to generate high-quality images with good aesthetics, but may not be able to consistently accurately render objects having attributes that are specified by the context input, e.g., may generate a depiction of the objects that does not match exactly the attributes of the objects, e.g., the count of each object or the special relationship between the objects, that are specified in the context input.

Deployment of the generative neural network 120 in the inference system is thus undesirable because these limitations lead to increased computation overhead of the inference system to mitigate these limitations and reduce the utility of the generated output data items.

For example, because the generative neural network 120 fails to accurately generate an image that aligns with a context input on the first try, the generative neural network 120 will require numerous regeneration attempts, each involving a reverse diffusion process across multiple updating iterations or an auto-regressive generation process, or require extensive post-processing operations, e.g., image or audio modification operations, making the data generation process computationally inefficient.

By fine-tuning the generative neural network 120, the training system 100 improves the performance of the generative neural network 120 in generative tasks, thus improving computational resource utilization efficiency of the inference system. As a result of the fine-tuning, the generative neural network 120 can generate output data items with higher quality and better prompt alignment with no additional consumption of computing resources compared to a generative neural network that has not been fine-tuned.

As a few examples, the generative neural network 120 can accurately generate images with improved image aestheticism, images that have values of a particular property that match a value for the property that is specified in the context input, e.g., images that have more legible text rendering, audio with improved audio quality metrics, e.g., music with a higher SNR (signal-to-noise ratio) or speech with a lower word error rate.

In particular, by using the CaPO loss, the training system 100 can achieve this improvement in a more computational resource-efficient manner, i.e., with reduced computational resource consumption, than other training systems that do not use the CaPO loss, e.g., a conventional fine-tuning system that uses a direct preference optimization (DPO) loss or another direct alignment loss.

A few examples of context inputs and output data items are described below.

The generative neural network 120 can be configured to generate any of a variety of output data items conditioned on any of a variety of context inputs.

For example, the generative neural network 120 can be configured to generate audio data, e.g., a waveform of audio or a spectrogram, e.g., a mel-spectrogram or a spectrogram where the frequencies are in a different scale, of the audio.

In this example, the context input can be text or features of text that the audio should represent, i.e., so that the generative neural network 120 serves as a text-to-speech machine learning model that converts text or features of the text to audio data for an utterance of the text being spoken.

As another example, the context input can identify a desired speaker for the audio, i.e., so that the generative neural network 120 generates audio data that represents speech by the desired speaker.

As another example, the context input can characterize properties of a song or other piece of music, e.g., lyrics, genre, and so on, so that the generative neural network 120 generates a piece of music that has the properties characterized by the context input.

As another example, the context input can specify a classification for the audio data into a class from a set of possible classes, so that the generative neural network 120 generates audio data that belongs to the class. For example, the classes can represent types of musical instruments or other audio emitting devices, i.e., so that the generative neural network 120 generates audio that is emitted by the corresponding class, or types of animals, i.e., so that the generative neural network 120 generates audio that represents noises generated by the corresponding animal, and so on.

As another particular example, the output data item can be an image, such that the generative neural network 120 can perform conditional image generation by generating the intensity values of the pixels of the image. In general the context input can specify one or more characteristics for the image.

In this particular example, the context input can be a sequence of text and the output data item can be an image that describes the text, i.e., the context input can be a caption for the output image.

As yet another particular example, the context input can be an object detection input that specifies one or more bounding boxes and, optionally, a respective type of object that should be depicted in each bounding box.

As yet another particular example, the context input can specify an object class from a plurality of object classes to which an object depicted in the output image should belong.

As another example, the context input can specify one or more images.

For example, the context input can specify an image at a first resolution and the output data item can include the image at a second, higher resolution.

For example, the context input can specify an image and the output data item can comprise a de-noised, enhanced, stylized, or otherwise edited version of the image.

As yet another particular example, the context input can specify an image including a target entity for detection, e.g. a tumor, and the output data item can comprise the image without the target entity, e.g., to facilitate detection of the target entity by comparing the images.

As yet another particular example, the context input can be a segmentation that assigns each of a plurality of pixels of the output image to a category from a set of categories, e.g., that assigns to each pixel a respective one of the category.

As yet another example, the context input can be a different type of structured input, e.g., a mesh or a graph that specifies properties of the image to be generated.

More generally, the context input can include one or more different types of inputs of one or more different modalities, e.g., only text, only one or more images, both text and one or more images, and so on.

As yet another example, the output data item can be a video. Again the context input can specify one or more characteristics for the video.

As a particular example, the context input can include text and the output data item can be a video described by the text.

As yet another particular example, the context input can include one or more images and the output data item can be a video that completes the one or images, e.g., video starting from the one or more images.

More generally, the task of generating the output data item can be any task that outputs continuous data conditioned on a context input. For example, the output can be an output of a different sensor, e.g., a lidar point cloud, a radar point cloud, an electrocardiogram reading, and so on, and the context input can represent the type of data that should be measured by the sensor. Where a discrete output is desired this can be obtained, e.g., by thresholding the outputs generated by the diffusion neural network.

In some applications, the output data item can be used in a control task to control an action of a mechanical agent acting in a real-world environment to perform a mechanical task. For example, the output data item can be processed by a policy neural network of the agent to select one or more actions to be performed by the agent as part of the task. The agent may then perform the one or more actions. The output data item (e.g., image) can, for example, characterize a state of the real-world environment that is predicted to be obtained by the agent performing the one or more actions. The context input can, e.g., specify a state of the real-world environment and the one or more actions. As another example the context input can specify a state of the real-world environment and the output data item can be used to select one or more actions to be performed by the mechanical agent to perform a task (i.e. the diffusion neural network can represent an action selection policy).

The training system 100 fine-tunes the generative neural network 120 over a plurality of fine-tuning steps. At each fine-tuning step, the training system 100 updates the parameters of the generative neural network 120 using a batch of training context inputs 102.

Each batch includes a plurality of training context inputs that are obtained, e.g., through sampling, from a training dataset 110 that stores a larger number of training context inputs.

Advantageously, the training system 100 need not have access to any preference data (e.g., human preference data). That is, the training dataset 110 need not store, for each training context input, any preference data that identifies a preference (e.g., human preference) among a plurality of training output data items generated conditioned on the training context input. Thus, the training system 100 obviates the computational costs associated with the generation of the human preference datasets and the limits on scalability of the fine-tuning process that are imposed by the requirement of human preference datasets.

By repeatedly performing the fine-tuning steps, the training system 100 repeatedly updates the values of the parameters of the generative neural network 120 to determine fine-tuned values of the parameters, i.e., from their trained values that have been determined as a result of the training, that will cause the generative neural network 120 to achieve the improved performance on the generative tasks.

More specifically, at each fine-tuning step, the training system 100 obtains a batch of training context inputs 102 and, for each training context input 102, processes the training context input 102 using the generative neural network 120 generate a plurality of training output data items 122A-122N (or “training outputs” for short).

The training system 100 includes or has access to one or more reward models 130A-130N that correspond respectively to each objective in a set of one or more objectives. Each reward model can have any of a variety of architectures, e.g., a convolutional neural network architecture, a fully connected neural network architecture, a Transformer neural network architecture, e.g., a vision-Transformer (ViT) neural network architecture.

For example, where the training outputs are images, the first reward model 130A can correspond to an image quality objective (e.g., the MPS reward model described in Sixian Zhang, et al. Learning multidimensional human preference for text-to-image generation. In IEEE Conference on Computer Vision and Pattern Recognition, 2024), the second reward model 130B can correspond to an image-prompt alignment objective (e.g., the VQAscore reward model described in Zhiqiu Lin, et al. Evaluating text-to-visual generation with image-to-text generation. In European Conference on Computer Vision, 2024), the third reward model 130C can correspond to an image aesthetics objective (e.g., the VILA reward model described in Junjie Ke, et al. Vila: Learning image aesthetics from user comments with vision-language pretraining. In IEEE Conference on Computer Vision and Pattern Recognition, 2023), and so on.

In some implementations the reward models are identified by the training system 100 in response to receiving data that defines the set of one or more objectives, e.g., by identifying a corresponding reward model for each objective in the set from a pool of reward models that are accessible by the training system 100.

For each training output in the plurality of training outputs 122A-122N, each reward model in the one or more reward models 130A-130N is configured to generate a reward score for the training output with respect to the objective that corresponds to the reward model. In cases where there are multiple reward models, the training system 100 can use different reward models to generate different reward scores for the same training output.

Each reward model measures a respective aspect of a training output, and the reward scores generated by different reward models for the same training output may differ. For example, where the training outputs are images, the first reward model 130A can generate a first reward score for a training output that measures an image quality of the training output, the second reward model 130B can generate a second reward score for a training output that measures an image-prompt alignment of the training output with respect to a corresponding training context input, and the third reward model 130C can generate a third reward score for a training output that measures an image aesthetics of the training output.

For each training output in the plurality of training outputs 122A-122N, a calibration engine 140 of the training system 100 generates a calibrated reward 142 for the training output with respect to each objective in the set based on the reward scores generated by using the reward model that corresponds to the objective for each training output in the plurality of training outputs 122A-122N.

Thus, the calibration engine 140 generates the calibrated reward 142 for each training output based not only on the reward score for the training output itself, but also on the reward scores for other training outputs that have been generated based on the same training context input 102. The goal of this calibration is to transform these raw reward scores into a calibrated metric that approximates the general preference under the same objective.

At each fine-tuning step, an update engine 150 of the training system 100 then trains the generative neural network 120 by generating the updates, i.e., updates to the values of the parameters of the generative neural network 120, for the generative neural network 120 based on optimizing, e.g., minimizing, a calibrated preference optimization (CaPO) loss.

The CaPO loss can either be applied in a single objective setting (in which a single reward model is used by the training system 100 and hence, a single calibrated reward is generated by the calibration engine 140), or can alternatively be applied in a multi-objective setting (in which multiple reward models are used by the training system 100 and hence, multiple calibrated rewards are generated by the calibration engine 140).

In either setting, the CaPO loss is based on the calibrated reward(s) 142 determined by the calibration engine 140 from the reward scores that are generated by the one or more reward models 130A-130N for the plurality of training outputs 122A-122N generated by the generative neural network 120 for each training context input 102 in the batch obtained by the training system 100 for the fine-tuning step.

After fine-tuning, the training system 100 or another inference system can deploy the fine-tuned generative neural network 120 that has the parameters having the fine-tuned values that have been determined as a result of the fine-tuning, on one or more computing devices to generate new output data items for the generative tasks based on new context inputs.

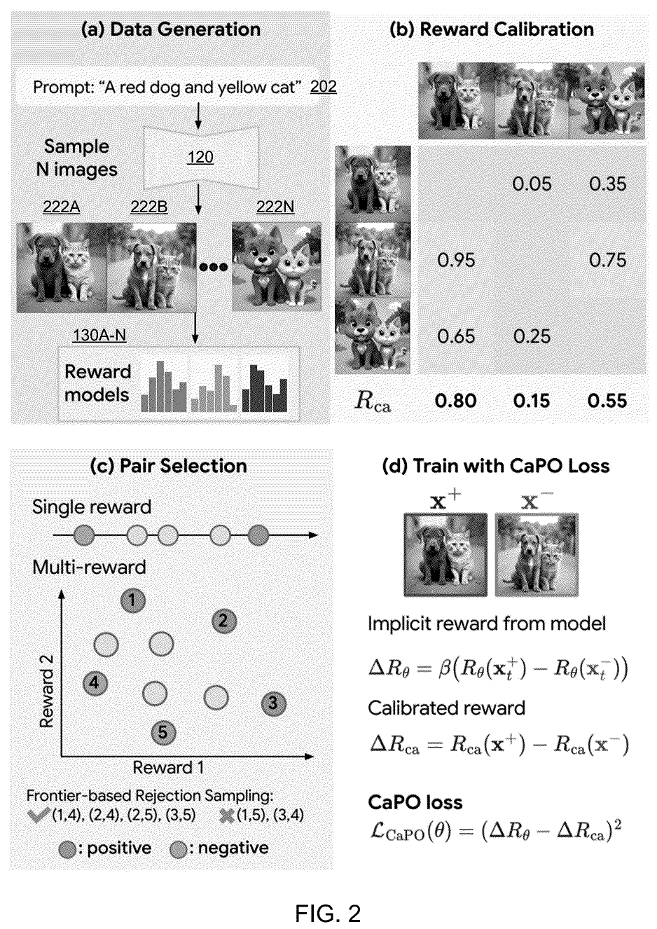

FIG. 2 is an example illustration of operations performed by the training system 100 of FIG. 1 to train the neural network at a fine-tuning step. These operations are conceptually grouped into four stages: a data generation stage, a reward calibration stage, a pair selection stage, and a training with CaPO loss stage. The training system 100 can repeatedly perform these operations for each training context input in the batch of training context inputs obtained at each fine-tuning step.

At the data generation stage, the training system 100 uses the generative neural network 120 to generate N training outputs 222A-222N conditioned on a training context input 202. In the example of FIG. 2, the training system 100 uses the generative neural network 120 to generate N images conditioned on a context input that is in the format of a text prompt: “A red dog and yellow cat.”

For each of the N training outputs 222A-222N, the training system 100 processes the training output using each of the one or more reward models 130A-130N to generate a reward score for the training output. Each reward model corresponds to a respective objective in a set of objectives.

In the example of FIG. 2, the training outputs are images, and there is a total of three objectives in the set of objectives: an image quality objective, an image-prompt alignment objective, and an image aesthetics objective. The first reward model 130A can correspond to the image quality objective, the second reward model 130B can correspond to the image-prompt alignment objective, and the third reward model 130C can correspond to the image aesthetics objective.

At the reward calibration stage, the calibration engine 140 of training system 100 generates a calibrated reward with respect to each objective in the set of objectives for each of the N training outputs 222A-222N. Thus, in the example of FIG. 2, the calibration engine 140 of generates a calibrated reward (0.80) with respect to one of the three objectives (e.g., the first objective) in the set for the first training output, a calibrated reward (0.15) with respect to the same objective for the second training output, and a calibrated reward (0.55) with respect to the same objective for the third training output.

To generate a calibrated reward with respect to an objective (e.g., the first objective) for a given training output, the calibration engine 140 determines a plurality of quality scores of the given training output based on the reward scores for the N training outputs 222A-222N generated by the reward model that corresponds to the objective, and then determines the calibrated reward with respect to the objective for the given training output based on the plurality of quality scores of the given training output.

In particular, a quality score of the given training output in the N training outputs 222A-222N indicates a preference, e.g., a human preference, of the given training output over another training output in the N training outputs 222A-222N with respect to the objective, and the calibration engine 140 generates a total of N−1 quality scores of the given training output: it generates one quality score for each pair of training outputs that includes the given training output and a different training output in the N training outputs 222A-222N.

The quality score generally represents a measure of preference of the training output over the other training output. In some implementations, the quality score may be a probability score between 0 and 1 that represents the probability that a training output is preferred over another training output, given a training context input. Hence a quality score of a given training output may also be called a “win-rate” of the given training output against another training output.

For example, in FIG. 2, the calibration engine 140 generates a total of two quality scores of a first training output with respect to the objective: a quality score (0.95) of the first training output relative to a second training input, indicating that the calibration engine 140 estimates a probability of 95% that the first training output is preferred over the second training input with respect to the objective, and another quality score (0.65) of the first training output relative to a third training input, indicating that the calibration engine 140 estimates a probability of 65% that the first training output is preferred over the third training input with respect to the objective.

For each training output, the calibration engine 140 determines the calibrated reward with respect to the objective for the training output based on the plurality of quality scores of the training output with respect to the objective. That is, the calibration engine 140 transforms the multiple (N−1) quality scores have been generated for a given training output into a single calibrated reward for the given training output.

For example, in FIG. 2, the calibration engine 140 generates a calibrated reward (0.80) for the first training output with respect to the objective based on the two quality scores (0.95, 0.65) of the first training output, a calibrated reward (0.15) for the second training output with respect to the objective based on the two quality scores (0.05, 0.25) of the second training output, and a calibrated reward (0.55) for the third training output with respect to the objective based on the two quality scores (0.35, 0.75) of the third training output.

At the pair selection stage, the training system 100 selects a pair of training outputs that includes a positive training output and a negative training output from the N training outputs 222A-222N based on the calibrated reward determined by the calibration engine 140 for each training output with respect to each objective in the set of objectives.

In the case of a single objective setting (in which a single reward model is used by the training system 100 and hence, a single calibrated reward is generated by the calibration engine 140), the training system 100 can select the pair by selecting the training output that has the highest calibrated reward among the N training outputs 222A-222N (“the best-of-N training output”) as the positive training output, and selecting the training output that has the lowest calibrated reward among the N training outputs 222A-222N (“the worst-of-N training output”) as the negative training output.

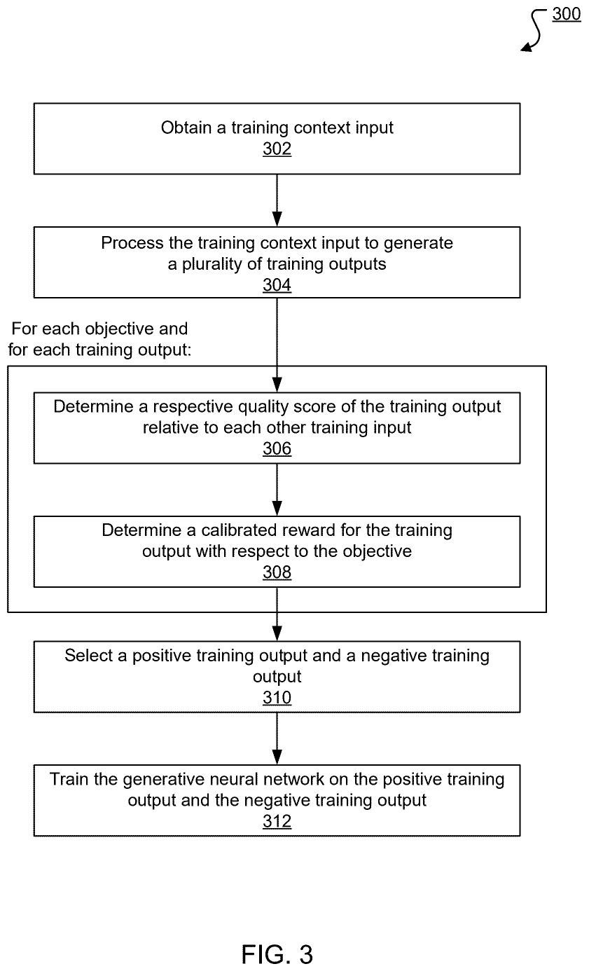

In the case of multi-objective setting (in which multiple reward models are used by the training system 100 and hence, multiple calibrated rewards are generated by the calibration engine 140), the training system 100 can use a Frontier-based rejection sampling technique to select the pair, as will be explained below with reference to step 310 of FIG. 3.

The Frontier-based rejection sampling technique applies a non-dominated sorting algorithm to the calibrated rewards for each training output across the multiple objectives to generate an upper Pareto frontier set that includes a first subset of the N training outputs 222A-222N, and a lower Pareto frontier set that includes a second subset of the N training outputs 222A-222N.

One of the training outputs in the upper Pareto frontier set can then be selected as the positive training output, and one of the training outputs in the lower Pareto frontier set can then be selected as the negative training output.

In doing so, the training system 100 identifies sets of training output that represent the most and least desirable training outputs across multiple, potentially conflicting reward signals to ensure optimization toward a Pareto optimal solution.

At the training with CaPO loss stage, the update engine 150 computes a CaPO loss component of a loss for the generative neural network 120 based on the positive training output (x⁺) and the negative training output (x⁻). How the update engine 150 computes the CaPO loss component based on the positive training output (x⁺) and the negative training output (x⁻) will be explained below with reference to step 312 of FIG. 3.

Having performed these operations for each training context input in the batch of training context inputs obtained for the fine-tuning step to determine a corresponding CaPO loss component for each training context input, the training system 100 then proceeds to train the generative neural network 120 to update the values of the parameters of the generative neural network 120 by combining the CaPO loss components (and possibly additional loss components computed using an objective function) across the training context inputs in the batch and then applying a gradient-based training technique to the combined loss components.

FIG. 3 is a flow diagram of an example process 300 for training a generative neural network that has parameters. For convenience, the process 300 will be described as being performed by a system of one or more computers located in one or more locations. For example, a training system, e.g., the training system 100 depicted in FIG. 1, appropriately programmed in accordance with this specification, can perform the process 300.

The system obtains a training context input (step 302). The training context input can be one of a plurality of training context inputs included in a batch of training context inputs that is obtained through random sampling from a larger number of training context inputs stored in the training dataset. The batch of training context inputs can include a fixed number of training context inputs, e.g., 128, 256, or 512.

The system processes, by the generative neural network, the training context input to generate a plurality of training outputs based on the training context input (step 304).

In some implementations where the generative neural network is configured as a diffusion neural network, the generative neural network can generate each training output across multiple reverse diffusion steps by performing a reverse diffusion process.

In some implementations where the generative neural network is configured as an auto-regressive generative neural network, the generative neural network is configured to execute an auto-regressive generation process to generate each training output in the plurality of training outputs, e.g., in parallel with each other training output.

The system repeatedly performs the following steps 306-308 for each objective in a set of one or more objectives and for each of the plurality of training outputs that have been generated by using the generative neural network based on the training context input.

The system determines a plurality of quality scores of the training output with respect to the objective (step 306). The plurality of quality scores are determined based on the reward scores for the plurality of training outputs generated by a reward model that corresponds to the objective. The plurality of quality scores includes a respective quality score of the training output relative to each other training input in the plurality of training outputs with respect to the objective.

To determine the respective relative quality score of the training output relative to another training input, the system processes a first reward model input that includes (i) the training output and, optionally, (ii) the training context input using the reward model to generate a first reward score for the training output with respect to the objective. The system processes a second reward model input that includes (i) the other training output and, optionally, (ii) the training context input using the reward model to generate a second reward score for the training output with respect to the objective.

The system determines a quality score of the training output relative to the other training input based on the first and second reward scores. The quality score generally represents a measure of preference of the training output over the other training output. There are many ways in which the quality score can be determined based on the first and second reward scores.

For example, the system can apply a Bradley-Terry algorithm to the first and second reward scores to generate the quality score of the training output relative to the other training input. The Bradley-Terry algorithm generates the quality score by applying the sigmoid function to the difference between the first and second reward scores:

$$ℙ ( x {x}^{′} \vert c ) : = σ ( R ( x , c ) - R ( {x}^{′} , c ) ) ,$$

where σ(u)=(1+exp(−u))⁻¹ is a sigmoid function, R(x, c) is the first reward score generated by the reward model based on processing the training output x and the training context input c, and R(x′, c) is the second reward score generated by the reward model based on processing the other training output x′ and the training context input c.

As another example, the system can apply a Thurstone-Mosteller algorithm to the first and second reward scores to generate the quality score of the training output relative to the other training input. Unlike the Bradley-Terry algorithm, which uses a sigmoid function, the Thurstone-Mosteller algorithm uses a probit function.

In either example, the quality score may be a probability score between 0 and 1 that represents the probability that the training output is preferred over the other training output, given a training context input.

The system determines a calibrated reward for the training output with respect to the objective based on the plurality of quality scores of the training output with respect to the objective (step 308). For example, the calibrated reward can be an average, a maximum, or a minimum of the plurality of quality scores of the training output with respect to the objective.

The system selects a pair of training outputs that includes a positive training output and a negative training output from the plurality of training outputs (step 310). The selection of the positive and negative training outputs is made in accordance with the calibrated rewards determined with respect to the one or more objectives for each training output.

In the case of a single objective setting, the system can select the pair by selecting the training output that has the highest calibrated reward among the plurality of training outputs as the positive training output, and selecting the training output that has the lowest calibrated reward among the plurality of training outputs as the negative training output.

In the case of multi-objective setting, the system can use a Frontier-based rejection sampling technique to select the pair. The Frontier-based rejection sampling technique applies a non-dominated sorting algorithm to the calibrated rewards for each training output across the multiple objectives to generate, based on the calibrated reward for each training output with respect to each objective, an upper Pareto frontier set that includes a first subset of the plurality of training outputs, and a lower Pareto frontier set that includes a second subset of the plurality of training outputs.

In some implementations, a training output “dominates” another training output when the calibrated reward for the training output is no less than the calibrated reward for the other training output with respect to each of the multiple objectives.

The first subset of the plurality of training outputs are the non-dominated training outputs which perform well, i.e., have higher calibrated reward scores, across all of the multiple objectives. For example, in FIG. 2, the upper Pareto frontier set includes training output 1, training output 2, and training output 3.

The second subset of the plurality of training outputs are the dominated training outputs which are suboptimal, i.e., have lower calibrated reward scores, across the multiple objectives. For example, in FIG. 2, the lower Pareto frontier set includes training output 4 and training output 5.

Having partitioned the plurality of training outputs into the upper Pareto frontier set and the lower Pareto frontier set, one of the training outputs in the upper Pareto frontier set can then be selected, e.g., through sampling, as the positive training output, and one of the training outputs in the lower Pareto frontier set can then be selected, e.g., through sampling, as the negative training output. For example, in FIG. 2, training output 1 and training output 4 can be selected as the pair. Analogously, training output 2 and training output 4 can be selected as the pair.

The system computes a loss of the generative neural network (step 312). The loss includes a CaPO loss component that is computed based on the positive training output and the negative training output. The loss of the generative neural network can be computed by evaluating an objective function.

Depending on the configuration of the generative neural network, the loss can include additional loss components, which may also be computed based on the positive training output and the negative training output.

For example, when the generative neural network is configured as a diffusion neural network, the objective function used to compute the loss of the generative neural network for each training context input can be:

$${ℒ}_{CaPO} ( θ ) = {𝔼}_{t , ϵ , {ϵ}^{′}} [ {( {R}_{ca} ( {x}^{+} , c ) - {R}_{ca} ( {x}^{-} , c ) - β ( {R}_{θ} ( {x}_{t}^{+} , c , t ) - {R}_{θ} ( {x}_{t}^{-} , c , t ) ) )}^{2} ]$$

where xₜ⁺=αₜx⁺+αₜ∈⁺+, xₜ⁻=αₜx⁻+αₜ∈⁻, for t˜U(0,1), (∈⁺, ∈⁻)˜U(0, 1), (∈⁺, ∈⁻)˜N(0,I)×N(0,I), and θ represents the parameters of the generative neural network. β is a tunable hyperparameter. αₜ is a part of a noise scheduling function, e.g., that satisfies the conditions of: αₜ₌₀≈1 and αₜ₌₁≈0.

In this example, the objective function includes a first term R_{ca}(x⁺, c)−R_{ca}(x⁻, c) that measures a difference between (i) a calibrated reward R_{ca}(x⁺, c) for the positive training output x⁺ with respect to each objective in the set of one or more objectives and (ii) a calibrated reward R_{ca}(x⁻, c) for the negative training output x⁻ with respect to each objective in the set of one or more objectives.

This first term computes the CaPO loss component of the loss of the generative neural network. In some implementations, the generative neural network can be trained based on optimizing an objective function that includes just this first term, e.g., when the generative neural network is configured as an auto-regressive generative neural network.

The CaPO loss component represents the external preference signal. It provides a robust and unified metric for maximization by approximating the expected win-rate against a pre-trained generative neural network. Using this calibrated signal, rather than raw reward scores, helps to minimize inconsistencies between multiple black-box reward models and mitigate reward hacking and overfitting, as the scores are bounded in the range.

The objective function includes a second term β(R_{θ}(xₜ⁺, c, t)−R_{θ}(xₜ⁻, c, t) that is dependent on a first denoising output (an estimate of the noise component) that is generated by the generative neural network from processing a denoising input that includes (i) a noisy positive training output xₜ⁺ that is generated based on adding noise to the positive training output, (ii) the training context input c, and (iii) data defining a noise level t, and on a second denoising output (an estimate of the noise component) that is generated by the generative neural network from processing a denoising input that includes (i) a noisy negative training output xₜ⁻ that is generated based on adding noise to the negative training output, (ii) the training context input c, and (iii) data defining a noise level t.

The second term measures a difference between (i) an inherent reward for the positive training output that is dependent on the first denoising output generated by the generative neural network and (ii) an inherent reward for the negative training output that is dependent on the second denoising output generated by the generative neural network.

The inherent reward for the positive training output R_{θ}(xₜ⁺, c, t) can be determined as a difference between (i) a difference between (a) the first denoising output generated by the generative neural network and (b) a ground truth noise component included in the noisy positive training output (i.e., the ground truth noise component that was added in accordance with a noise level that is dependent on a noise schedule to the positive training output to arrive at the noisy positive training output) and (ii) a difference between (a) a denoising output generated by a reference diffusion neural network from processing a denoising input that includes (i) the noisy positive training output, (ii) the training context input, and (iii) data defining the noise level and (b) the ground truth noise component included in the noisy positive training output.

The inherent reward for the negative training output R_{θ}(xₜ⁻, c, t) can be determined as a difference between (i) a difference between (a) the second denoising output generated by the generative neural network and (b) a ground truth noise component included in the noisy negative training output (i.e., the ground truth noise component that was added in accordance with a noise level that is dependent on a noise schedule to the negative training output to arrive at the noisy negative training output) and (ii) a difference between (a) a denoising output generated by the reference diffusion neural network from processing a denoising input that includes (i) the noisy negative training output, (ii) the training context input, and (iii) data defining the noise level and (b) the ground truth noise component included in the noisy negative training output.

This second term computes the inherent reward loss component of the loss of the generative neural network. The reference diffusion neural network can be another instance of the diffusion neural network that is being fine-tuned. For example, the reference diffusion neural network can be an already-trained generative neural network before it undergoes fine-tuning based on optimizing the CaPO loss.

The inherent reward loss component represents the preference signal implicitly learned by the generative neural network itself. By forcing the internal model signal (the inherent reward loss component) to match the reliable, external calibrated preference difference (the CaPO loss component), the generative neural network is fine-tuned effectively to maximize the gain without falling victim to reward over-optimization.

In some implementations, the system further applies a timestep-aware loss weighting to the inherent reward loss component to improve the diffusion preference optimization and achieve enhanced performance compared to using constant weighting.

For example, the system can compute an inherent reward for the positive (or negative) training output as:

$${R}_{θ} ( {x}_{t} , c , t ) = {w}_{t} {λ}_{t}^{′} ( {‖ {ϵ}_{θ} ( {x}_{t} ; c , t ) - ϵ ‖}_{2}^{2} - {‖ {ϵ}_{ref} ( {x}_{t} ; c , t ) - ϵ ‖}_{2}^{2} )$$

where ∈_{θ} is an estimate of the noise component generated by the generative neural network, ∈_{ref} is an estimate of the noise component generated by the reference diffusion neural network, xₜ is the noisy training output at time t, generated from the original training output x as xₜ=αₜx+σₜ∈, ∈ represents the actual noise added to the original training output. The term

$${‖ {ϵ}_{θ} ( {x}_{t} ; c , t ) - ϵ ‖}_{2}^{2}$$

is the noise prediction loss of the generative neural network. The term λₜ′=dλ/dt is the time derivative of the log signal-to-noise ratio (λₜ), which scales the difference. wₜ is the weighting function, e.g., a sigmoid weighting function (wₜ=w(λₜ)).

Iterations of the process 300 can be repeatedly performed on multiple different batches of training context inputs obtained from the training dataset, where the iterations of the process 300 performed on the training context inputs in the same batch may be grouped into a fine-tuning step, in order to train the generative neural network to update values of the parameters of the generative neural network based on optimizing the objective function.

That is, the system can repeatedly perform an iteration of the process 300 on each training context input included in a batch of training context inputs, e.g., perform an iteration of the process 300 on each training context input in parallel with other training context inputs in the batch, to compute a corresponding loss that includes at least a corresponding CaPO loss component that is computed based on the positive training output and the negative training output obtained from the plurality of training outputs generated based on the training context input, combine the losses, e.g., by averaging the losses, compute gradients of the parameters of the generative neural network based on the combined loss, e.g., by backpropagation, and then apply an optimizer, e.g., an Adam optimizer, an Rmsprop optimizer, or a stochastic gradient descent (SGD) optimizer, to the computed gradients.

An iteration of steps 302-308 of the process 300 can also be performed by the training system or an inference system as part of generating an output data item for a context input after the fine-tuning process, i.e., at inference time. In these cases the training context input may be a context input that is received by the inference system from a user computing device, and each training output may be a candidate output data item (“candidate output” for short).

For example, the user computing device can be provided with an input mechanism, such as a text or voice interface, that enables user input from a user in a natural language. The user computing device may be provided with an output mechanism that provides a final output data item for the user in a same or different way, e.g., by displaying an image, a video, or audio. The input and output mechanism can include, e.g., a keyboard, microphone, speaker, display, and/or camera.

At inference time, having determined a calibrated reward for each candidate output with respect to each objective, the inference system can then select, from the plurality of candidate outputs and in accordance with the calibrated rewards with respect to the one or more objectives for each candidate output, a selected candidate output as the final output data item, e.g., by selecting the best-of-N candidate output in the case of a single objective setting, or by sampling from an upper Pareto frontier set of candidate outputs in the case of a multi-objective setting.

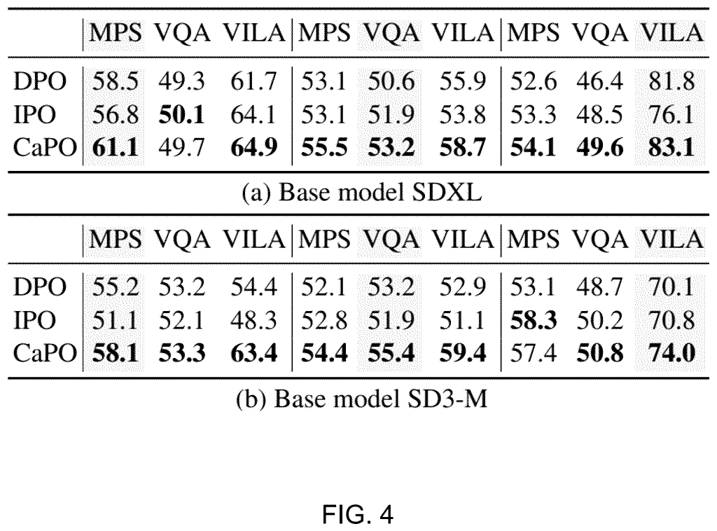

FIG. 4 shows an example of performance improvement achieved by the described fine-tuning technique when the output data items are images and the context inputs are text prompts.

The tables in FIG. 4 list the win-rates of a diffusion neural network that has been fine-tuned based on optimizing a CaPO loss over 2 base diffusion neural networks (one that has been fine-tuned based on optimizing a direct preference optimization (DPO) loss, e.g., as described in Bram Wallace, et al. Diffusion model alignment using direct preference optimization. In IEEE Conference on Computer Vision and Pattern Recognition, 2024, and another that has been fine-tuned based on optimizing an IPO loss, e.g., as described in Mohammad Gheshlaghi Azar, et al. A general theoretical paradigm to understand learning from human preferences. In International Conference on Artificial Intelligence and Statistics, 2024) with respect to 3 different objectives: an image quality objective (MPS), an image-prompt alignment objective (VQA), and an image aesthetics objective (VILA).

In the top table, the diffusion neural network has a Stable Diffusion XL (SDXL) architecture, e.g., as described in Dustin Podell, et al. Sdxl: Improving latent diffusion models for high-resolution image synthesis. In International Conference on Learning Representations, 2024. In the bottom table, the diffusion neural network has a Stable Diffusion 3 medium (SD3-M) architecture, e.g., as described in Patrick Esser, et al. Scaling rectified flow transformers for high-resolution image synthesis. In International Conference on Machine Learning, 2024.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computed-implemented method for training a generative neural network that has parameters, wherein the method comprises:
obtaining a context input;
processing, by the generative neural network, the context input to generate a plurality of training outputs;
for each objective in a set of one or more objectives and for each of the plurality of training outputs:
determining a respective quality score of the training output relative to each other training input in the plurality of training outputs with respect to the objective; and
determining a calibrated reward for the training output with respect to the objective based on the respective quality scores of the training output with respect to the objective;
selecting, from the plurality of training outputs and in accordance with the calibrated rewards with respect to the one or more objectives for each training output, a positive training output and a negative training output; and
training the generative neural network on the positive training output and the negative training output to update values of the parameters of the generative neural network.

2. The method of claim 1, wherein determining the respective quality score of the training output relative to each other training input in the plurality of training outputs with respect to the objective comprises:
processing a first reward model input that comprises at least the training output using a reward model that corresponds to the objective to generate a first reward score for the training output with respect to the objective;
processing a second reward model input that comprises at least another training output using the reward model that corresponds to the objective to generate a second reward score for the other training output with respect to the objective; and
determining a quality score of the training output relative to the other training input based on the first and second reward scores.

3. The method of claim 2, wherein the first reward model input also comprises the context input.

4. The method of claim 1, wherein determining the calibrated reward for the training output based on the respective quality scores of the training output with respect to the objective comprises:
computing an average of the respective quality scores of the training output with respect to the objective.

5. The method of claim 1, wherein the set of one or more objectives includes only a single objective, and wherein selecting the positive training output and the negative training output comprises:
selecting, as the positive training output, a training output from the plurality of training outputs that has a highest calibrated reward with respect to the single objective; and
selecting, as the negative training output, a training output from the plurality of training outputs that has a lowest calibrated reward with respect to the single objective.

6. The method of claim 1, wherein the set of one or more objectives comprises multiple objectives, and wherein selecting the positive training output and the negative training output comprises:
applying a non-dominated sorting algorithm to the calibrated rewards with respect to the multiple objectives for each training output.

7. The method of claim 1, wherein training the generative neural network on the positive training output and the negative training output comprises:
training the generative neural network on the positive training output and the negative training output based on optimizing an objective function that includes a first term that measures a difference between (i) a calibrated reward for the positive training output with respect to each objective in the set of one or more objectives and (ii) a calibrated reward for the negative training output with respect to each objective in the set of one or more objectives.

8. The method of claim 7, wherein the objective function also includes a second term that is dependent on an estimated noise that is generated by the generative neural network from processing at least a noisy positive training output, an estimated noise that is generated by the generative neural network from processing at least a noisy negative training output, or both.

9. The method of claim 8, wherein the second term measures a difference between (i) an inherent reward for the positive training output that is dependent on the estimated noise that is generated by the generative neural network from processing at least the noisy positive training output and (ii) an inherent reward for the negative training output that is dependent on the estimated noise that is generated by the generative neural network from processing at least the noisy negative training output.

10. The method of claim 9, wherein the inherent reward for the positive training output is determined as a difference between (i) a difference between (a) the estimated noise that is generated by the generative neural network from processing at least the noisy positive training output and (b) a ground truth noise included in the noisy positive training output and (ii) a difference between (a) the estimated noise that is generated by a reference neural network from processing at least the noisy positive training output and (b) the ground truth noise included in the noisy positive training output.

11. The method of claim 9, wherein the inherent reward for the negative training output is determined as a difference between (i) a difference between (a) an estimated noise that is generated by the generative neural network from processing at least a noisy negative training output and (b) a ground truth noise included in the noisy negative training output and (ii) a difference between (a) an estimated noise that is generated by a reference neural network from processing at least the noisy negative training output and (b) the ground truth noise included in the noisy negative training output.

12. The method of claim 9, wherein the noisy positive training output is generated by combining the positive training output and the ground truth noise in accordance with a noise level that is dependent on a noise schedule, and wherein the generative neural network also processes data that identifies the noise level.

13. The method of claim 1, wherein the generative neural network has been pre-trained on an unlabeled training dataset to optimize one or more unsupervised or self-supervised objective functions.

14. The method of claim 1, wherein the generative neural network comprises a diffusion neural network, and wherein the training output comprises one of image data, video data, or audio data.

15. The method of claim 1, further comprising using the generative neural network to generate a new output conditioned on a new context input, wherein the output comprises one of image data, video data, or audio data.

16. A computed-implemented method comprising:
obtaining a context input;
processing, by a generative neural network, the context input to generate a plurality of candidate outputs;
for each objective in a set of one or more objectives and for each of the plurality of candidate outputs:
determining a respective quality score of the candidate output relative to each other training input in the plurality of candidate outputs with respect to the objective; and
determining a calibrated reward for the candidate output with respect to the objective based on the respective quality scores of the candidate output with respect to the objective; and
selecting, from the plurality of candidate outputs and in accordance with the calibrated rewards with respect to the one or more objectives for each training output, a selected candidate training output as the final output.

17. A system comprising one or more computers and one or more storage devices storing instructions that, when executed by the one or more computers, cause the one or more computers to perform operations for training a generative neural network that has parameters, wherein the operations comprise:
obtaining a context input;
processing, by the generative neural network, the context input to generate a plurality of training outputs;
for each objective in a set of one or more objectives and for each of the plurality of training outputs:
determining a respective quality score of the training output relative to each other training input in the plurality of training outputs with respect to the objective; and
determining a calibrated reward for the training output with respect to the objective based on the respective quality scores of the training output with respect to the objective;
selecting, from the plurality of training outputs and in accordance with the calibrated rewards with respect to the one or more objectives for each training output, a positive training output and a negative training output; and
training the generative neural network on the positive training output and the negative training output to update values of the parameters of the generative neural network.

18. The system of claim 17, wherein determining the respective quality score of the training output relative to each other training input in the plurality of training outputs with respect to the objective comprises:
processing a first reward model input that comprises at least the training output using a reward model that corresponds to the objective to generate a first reward score for the training output with respect to the objective;
processing a second reward model input that comprises at least another training output using the reward model that corresponds to the objective to generate a second reward score for the other training output with respect to the objective; and
determining a quality score of the training output relative to the other training input based on the first and second reward scores.

19. The system of claim 18, wherein the first reward model input also comprises the context input.

20. The system of claim 17, wherein determining the calibrated reward for the training output based on the respective quality scores of the training output with respect to the objective comprises:
computing an average of the respective quality scores of the training output with respect to the objective.
